(19) United States
(12) Patent Application Publication
(10) Pub. No.: US 2022/0149602 A1
(43) Pub. Date: May 12, 2022

(54) APPARATUS FOR SECURING DEVICE TO TRANSMISSION LINES

(71) Applicant: Balmoral Engineering Pty Ltd, Hornsby, New South Wales (AU)

(72) Inventors: Chris Dengate, Hornsby, New South Wales (AU); Clive Solari, Hornsby, New South Wales (AU); Enzo Mesiti, Hornsby, New South Wales (AU)

(73) Assignee: Balmoral Engineering Pty Ltd, Hornsby, New South Wales (AU)

(21) Appl. No.: 17/310,057

(22) PCT Filed: Jul. 14, 2020
(86) PCT No.: PCT/AU2020/050017

§ 371 Date: Jul. 14, 2021

(30) Foreign Application Priority Data
Jan. 14, 2019 (AU) 2019900101

(51) Int. Cl. H02G 1/02; F16B 2/10; A01M 29/06

(52) U.S. Cl. CPC H02G 1/02; A01M 29/06; F16B 2/10

(57) ABSTRACT

Apparatus adapted for attachment to transmission lines, the apparatus comprising a warning marker; and a warning marker application tool for applying the warning marker to transmission lines; wherein the warning marker comprises: at least one securing means adapted to engage the transmission lines; a first handle and a second handle each connected to the at least one securing means; a spring-biased clamp means adjacent the proximal end at the least one securing means; an attachment means adjacent the at least one securing means; and wherein the application tool comprises: a base means; a first protrusion and a second protrusion each protruding from a surface of the base means; a screw mechanism attached to the base means; wherein the first protrusion and the second protrusion are each adapted to releasably engage with the first handle and the second handle respectively, to position and clamp the warning marker to the transmission lines.

### TECHNICAL FIELD

The present invention relates to an apparatus and/or system adapted for assisting the attachment of a marker system to an electrically charged item or other suitable objects thereto. The visual marker provides improved visibility and preferably reduces loading on a transmission line, distribution line, power line or other lines relative to known warning markers. More particularly, the apparatus or system is adapted to be a tool for ease of engaging or disengaging the visual marker to the lines.

### BACKGROUND

Warning markers are commonly used to highlight transmission lines such that transmission lines are not inadvertently touched or impacted upon. Warning markers are typically required for a number of purposes such as for; warning planes, allowing birds to differentiate transmission lines from a horizon, cable car applications, rope way structures and high-rise transmission lines. These devices are also typically used in agriculture, plants, mining, and construction sites.

Known warning markers include flags and ribbons. These warning markers can easily break or degrade and are not easily visible in certain orientations, particularly due to the relatively narrow dimensions of the device. To view these markers, a viewer would typically be required to stand at a substantially perpendicular orientation relative to the face of the marker. This can cause a number of issues, namely that there is no visual marker clearly visible while a person is oriented in any direction, such as a direction parallel to the face of the marker. In addition, if there are strong winds the markers may be forced into an orientation which is more difficult to view, such as the face of the marker being substantially parallel with the relative ground level.

Further, known warning markers typically induce an adverse loading on transmission lines, not only due to the weight of the marker, but also due to wind loading of the marker. Wind loading of transmission lines can cause damage and potentially cause blackouts or other electrical issues which are costly to repair. As such, there may be a need to provide a device which does not significantly adversely impact and/or load transmission lines.

Other known markers, such as obstruction marking spheres, may provide visual warning in multiple orientations however these devices are cumbersome and are not easily attachable to transmission lines. Notably, the transmission lines are typically required to be turned off, for installation of the obstruction marking spheres which causes power outages due to lines being turned off or cause great expense to install due to the lines being required to be turned off. Further, a user installing the device will typically be required to be in close proximity (i.e. in arms reach) to the transmission line to install the device or remove the device. These spheres also have the additional problems associated with wind loading and which causes stress to be applied to transmission lines, which again, may damage the transmission lines.

Current warning marker devices can only be attached from below a transmission line, or attached via helicopter or from an elevated work platform (such as a cherry picker or basket crane). This can provide a number of problems when attempting to fix a warning marker to lines below infrastructure, such as bridges and the like.

Other markers may be used primarily to reduce the potential for large birds to impact the transmission line as they may become confused between a transmission line and the horizon or do not see the lines. These markers typically called ‘bird diverters’, are generally wound around the transmission lines by hand and comprise a coiled orientation such that the line has a breaker which can assist with birds avoiding the transmission line. To attach these devices generally requires an installer to manually attach the device by hand and therefore, the use of an elevated platform or helicopter is generally required which is costly and time consuming.

In addition, most conventional clamps or securing means are formed from a conductive material, such as an aluminium (aluminium) alloy or galvanised steel. Such materials typically exclude the use of a hot stick or live line attachment method due to the risk of potential electrocution.

An additional problem associated with known markers is creep. Creep of line markers occurs during movement of transmission lines, which causes spaced apart markers to move closer to each other towards their respective nearest transmission line support (i.e. away from the middle of a transmission line) which requires the highest level of attention. Alternatively, the creep of markers may cause the markers to bunch together at a single location on the line.

Published US Patent Application No. US 2007/0137883 attempts to address some of these issues using a device for deterring birds from overhead cables such as power lines, and a method for employing the clamping means. The device comprises a first member having a hook portion for hooking on to the cable; a second member biased towards the hook portion; and biasing means for biasing the second member toward the hook portion. The first and second members are displaceable relative to each other between a first loaded position, wherein the biasing means is loaded, and a second clamped position, wherein the biasing means is at least partially unloaded thereby clamping the power line between the first member and the second member. The method includes hooking the clamping means onto the cable; and actuating the displacement of the first and second members relative to each other. However, this device and method does nothing to address the known difficulties associated with engaging and clamping warning marker devices on live transmission lines.

Australian Patent Application No. 2016102420 discloses a device adapted for use as a warning marker. The device comprises a device body with a first end and a second end, in which the first end and the second end define a longitudinal axis therebetween. A securing means may be attached to the device body first end. The device body comprises at least one projection projecting at an angle from the longitudinal axis of the device body; and wherein the device body is rotatable about the axis relative to securing means. This device also does not address the known difficulties associated with engaging and clamping warning marker devices on live transmission lines.

Any discussion of the prior art throughout the specification should in no way be considered as an admission that such prior art is widely known or forms part of common general knowledge in the field.

### SUMMARY

### Problems to be Solved

It is an aim and objective of the present invention to provide an apparatus which can be used to readily attach and detach a warning marker to a live transmission line.

It may be advantageous to provide an apparatus which can be used to attach a warning marker device to an electrically live surface.

It may be advantageous to provide for an apparatus that can be adapted to attach a warning marker to a transmission line from any angle.

It may be advantageous to provide an apparatus that can be adapted for use with a hot-stick for engaging and clamping a warning marker device to live transmission lines.

It may be advantageous to provide for a warning marker which may reduce loading on a transmission line.

It may be advantageous to provide an apparatus that can be adapted to contact a live transmission line during engagement and clamping a warning marker device to the transmission line.

It may be advantageous to provide an application tool that can be adapted to efficiently engage and disengage with a warning marker device before and after clamping the device to transmission lines. It may be advantageous to provide an apparatus and system that is relatively safer to use than previously known devices.

It is an object of the present invention to overcome or ameliorate at least one of the disadvantages of the prior art, or to provide a useful alternative.

In the context of the present invention, the words “comprise”, “comprising” and the like are to be construed in their inclusive, as opposed to their exclusive, sense, that is in the sense of “including, but not limited to”.

### Means for Solving the Problem

According to a first aspect, the invention provides an apparatus adapted for attachment to transmission lines, the apparatus comprising a warning marker; and a warning marker application tool for applying the warning marker to transmission lines; wherein the warning marker comprises: at least one securing means adapted to engage the transmission lines; a first handle and a second handle each connected to the at least one securing means; a spring-biased clamp means adjacent the proximal end at the least one securing means; an attachment means adjacent the at least one securing means; and wherein the application tool comprises: a base means; a first protrusion and a second protrusion each protruding from a surface of the base means; a screw mechanism attached to the base means; wherein the first protrusion and the second protrusion are each adapted to releasably engage with the first handle and the second handle respectively, to position and clamp the warning marker to the transmission lines.

Preferably, the second protrusion is moveable relative to the first protrusion via the longitudinal axis of the screw mechanism. When the protrusions are engaged with the respective handles, the movement of the second protrusion towards the first protrusion preferably moves the handles towards each other and opens or urge the at least one securing means apart to allow the transmission line to be received in the at least one securing means. When the transmission line has been received in the at least one securing means, the movement of the second protrusion away from the first protrusion preferably moves the handles away from each other allowing the securing of the at least one securing means via the spring-biasing means. The warning marker is preferably releasably clamped to the transmission lines via the spring-biased clamp means. In a preferred embodiment, the spring-biased clamp means has a 90° abutting relationship to the transmission lines.

The apparatus preferably comprises a first securing means and a second securing means.

Preferably, the movement of the second protrusion relative to the first protrusion along the longitudinal axis of the screw mechanism is a torsional movement. Rotational force is preferably applied to the application tool to instigate torsional movement.

Rotational torsional force can be applied to the application tool to enable clamping movement of the first securing means relative to the second securing means to position and clamp the warning marker to the transmission lines.

Preferably, the first securing means is a first jaw and the second securing means is a second jaw, wherein the first jaw is movably attached to the second jaw. The apparatus preferably comprises a first handle and a second handle.

The application tool preferably comprises a top protrusion and a bottom protrusion. In a preferred embodiment, the top protrusion and the bottom protrusion are adapted to engage with the first handle means and the second handle means of the warning marker. In use, the top protrusion may engage the first handle enabling the first jaw to connect the transmission line and the bottom protrusion may engage the second handle. The attachment means may be adapted to attach to a warning marker vane.

Preferably, the top protrusion is shaped to recover the warning marker device during application of the device on the transmission line.

According to a second aspect of the present invention, there is provided an apparatus adapted for attachment to transmission lines, the apparatus comprising: a warning marker; and a warning marker application tool for applying the warning marker to transmission lines; wherein the warning marker comprises: a first jaw and a second jaw, the first jaw movably attached to the second jaw at their respective proximal ends, a first handle means attached to proximal end of first jaw and a second handle means attached to proximal end of second jaw; a spring-biased clamp means adjacent a top surface of the first jaw; an attachment means adapted at attach to a warning marker vane; and wherein the application tool comprises:

a base means; a top protrusion and a bottom protrusion protruding from a front surface of the base means, the top protrusion and the bottom protrusion adapted to engage with the first handle means and the second handle means respectively; a screw mechanism adjacent the top protrusion and the bottom protrusion, wherein the screw mechanism is used to move the top protrusion and the bottom protrusion relative towards each other to open or urge the first jaw and the second jaw apart to receive the transmission line.

Preferably, the top protrusion is moveable relative to the bottom protrusion via the longitudinal axis of the screw. When the protrusions are engaged with the respective handles, the movement of the top protrusion towards the bottom protrusion moves the handles towards each other and opens or urges the at least one securing means apart to allow the transmission line to be received in the at least one securing means. When the transmission line has been received in the at least one securing means, the movement of the top protrusion away from the bottom protrusion moves the handles away from each other to return the at least one securing means back to the original spring-biased configuration. In a particularly preferred embodiment, the spring-biased clamp means has a 90° abutting relationship to the transmission lines.

Preferably, the top protrusion is parallel to the bottom protrusion.

Preferably, the top protrusion is relatively offset to the bottom protrusion. Preferably, the offset is in the range of 0 mm to 30 mm. Most preferably, the offset is 10 mm.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts a side view of an embodiment of a warning marker device according to the present invention.

FIG. 2 depicts a top view of the device of FIG. 1.

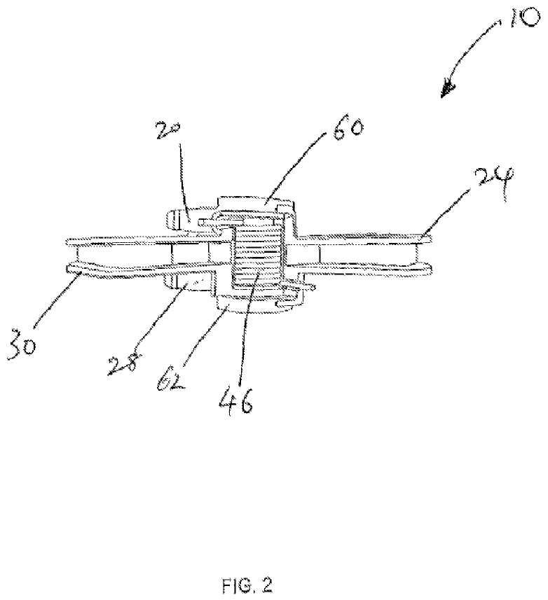

FIG. 3 depicts a perspective view of part of the device of FIG. 1 showing an attachment means.

FIG. 4 depicts a side view of an embodiment of an application tool according to the present invention, showing a top and a bottom protrusion.

FIG. 5 depicts a front-side perspective of the application tool of FIG. 4.

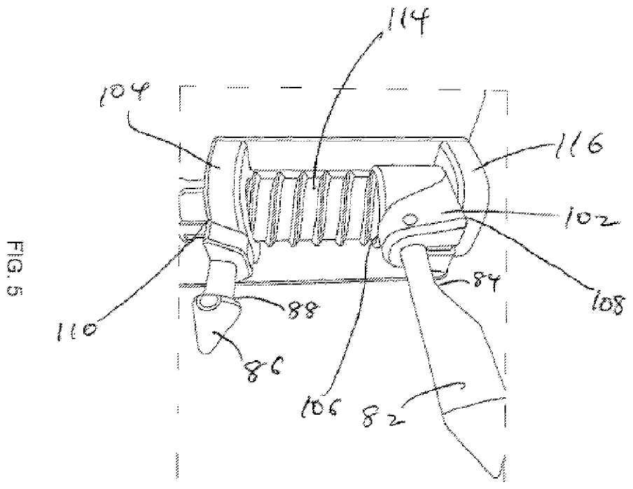

FIG. 6 depicts a back-side view of the application tool of FIG. 4.

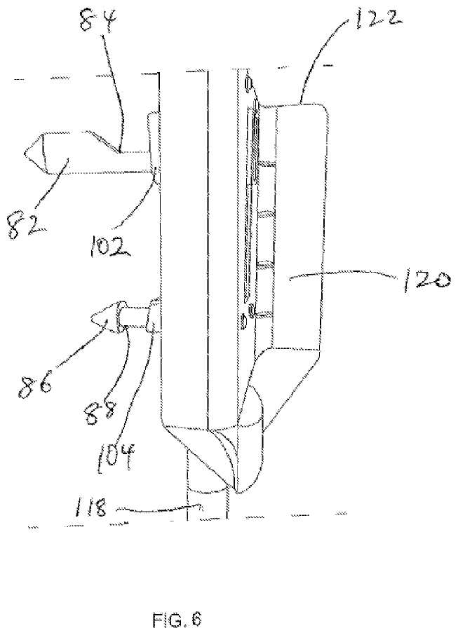

### DESCRIPTION OF THE INVENTION

Preferred embodiments of the invention will now be described with reference to the accompanying drawings and non-limiting examples.

Throughout this specification, the term “transmission line” may also refer to a power line, a distribution line or any other line or cable.

The present disclosure is directed towards an apparatus adapted for use with power lines or transmission lines. The apparatus is preferably designed for efficient engagement and disengagement of an application tool with a warning marker device to allow for clamping and removal of the device from live transmission lines in a manner that reduces the risk of electrocution of the operator and damage to the transmission lines.

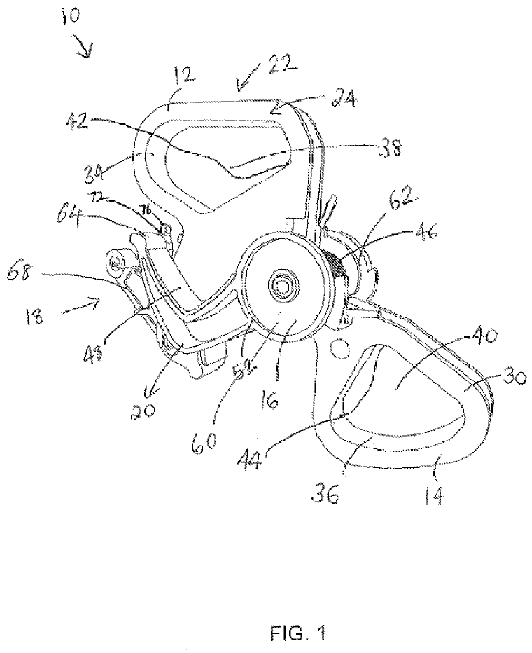

Referring to FIG. 1, the warning marker 10 comprises a first portion 12 and a second portion 14 joined by a rotatable hinge 16 mounted in approximately the centre of the warning marker 10. The first portion 12 comprises a first end 18 incorporating a first jaw 20 and a second opposed end 22 comprises handle means 24, which are preferably integrally moulded into a single piece construction. The second portion 14 comprises a first end 26 incorporating a second jaw 28 and a second handle means 30, which are preferably integrally moulded into a single piece construction.

Preferably the first and second portions 12, 14 are secured together about the hinge 16 in a scissor mechanism relationship so each portion can rotate about the hinge 16. Preferably, wherein the handle means 24, 30 are moved or squeezed together, the first jaw 20 and second jaw 28 move apart. When the handle means 24, 30 are separated or moved away from each other, the jaws 20 and 28 are adapted to move together. Preferably, the first handle means 24 may be a first loop handle 34, and the second handle means may be a second loop handle 36. Each of the loop handles 34, 36 may have a hole. The first hole 38 and the second hole 40 of the first and second loop handle may have a diamond or conical shaped profile. The curved portion 42 and 44 of the first and second shaped profile may advantageously position a digit or a protruded portion when it is applied through the loop handles 34, 36 be in the optimal position for squeezing the loop handles 34, 36 together against the spring tension of the spring-biased means to effect the movement of the jaws 20, 28 apart. The first hole 38 and second hole 40 may have a generally rounded triangular profile wherein the apex of the triangle preferably is directed in a direction away from the hinge whereby the triangular profile is adapted to maintain a relatively large hole area when viewed from beneath the warning marker when it is attached to a power line. The relatively large hole space may facilitate engagement of the attachment tool.

Preferably, the first loop handle 34 may have a hole 38 larger than the second loop 40. The first hole 38 of the first loop handle 34 may have an asymmetric profile in comparison to the second hole 40 of the second loop handle 36. This may be advantageous for allowing the bespoke application tool 80 with a first protruded portion 82 to find the hole 38 of the first loop handle 34 as well as for going through the hole 38 of the first loop handle 34. Preferably, a curved portion 42 of the conical profile of the hole 38 of the first loop handle 34 may assist in engaging a bevelled edge 84 of the first protrusion of the application tool. Once the first protrusion 82 of the application tool 80 has passed through the hole 38 of the first loop handle 34, and the bevelled edge 84 has engaged with the curved portion 42 of the conical profile, the second protrusion 86 of the application tool 80 may also engage with the second curved portion 44 of the conical profile of the second loop handle 36. The second protrusion 86 of the application tool 80 may have an umbrella-shape such that the second curved portion 44 of the conical profile of the second loop handle 36 may be retained at the underside of the umbrella conical shape 88. It may be appreciated that prior to the engagement of warning marker 10 and the application tool 80, the distance between the first curved portion 42 and the second curved portion 44 may be the same as the distance between the bevelled edge 84 and the underside of the umbrella conical shape 88.

A first handle means 24 is attached to proximal end of first jaw 20 and a second handle means 30 attached to proximal end of second jaw 28. A spring-biased clamp means 46 is adjacent a top surface 48 of the first jaw 20. Existing warning marker devices for transmission lines use a clamp means for attaching the device to the live transmission lines. These devices require significant spring tension to secure to the lines resulting in significant load for the lines to bear during installation and uninstallation. These devices can also vibrate down the live transmission line. This can cause damage to the transmission lines, causing them to short out and interrupt transmission. The spring-based clamp means of the present invention is designed to minimise any risk of damage to the power lines, and minimise the tension on power lines during installation and uninstallation of the warning marker, due to the combination of the spring-based clamp means applied using the screw-based application tool

The first jaw 20 may have a curved surface 48 adapted for engaging and retaining the transmission line or wire and the second jaw 28 may also have another curved surface 50 adapted for engaging and retaining the same transmission line or wire. The first jaw 20 and second jaw 28 may each have a proximal end 52, 56 and a distal end 54, 58. The proximal end of the first jaw 52 may be in connection to a first hinge portion 60 of the warning marker 10, and the proximal end of the second jaw 56 may be in connection to a second hinge portion 62 of the warning marker 10. The spring biasing means 46 may be connectedly positioned between the first hinge portion 60 and the second hinge portion 62 by the axle 32. The distal end of the first jaw 54 and the distal end of the second jaw 58 may each have a first boss 64 and a second boss 66 respectively for preventing the engaged transmission line to slip out of the grasp of the jaws. This additional safety line retention feature at the distal end of each of the jaws 20, 28 may advantageously improve the retention of the engaged transmission line.

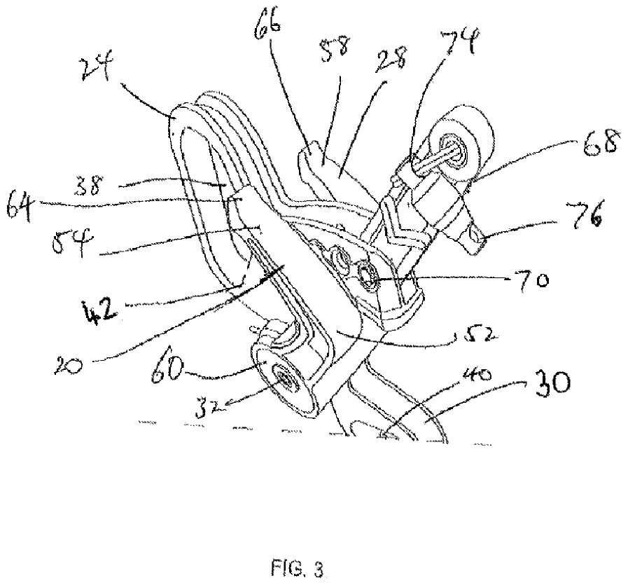

As illustrated in FIGS. 1 and 3, an attachment means 68 hingedly connected 70 to the warning marker 10 may be used to attach a warning marker vane. The vane may be, for example, a fixed or rotating reflective marker or a solar powered cats eye that is clearly visible to helicopters, birds and other air traffic (not shown in the illustrations). The vane may also be a rotating vane, as described in the earlier Australian Published Patent Application No. 2016102420 and the description of '420 is herein included within this current specification.

The attachment means 68 may be a toggle 72 or swivel device with an end 74 allowing for the engagement to the warning marker 10. The toggle 72 may be tied to the warning marker 10 by a strap of a non-conductive material. The toggle 72 may be adapted to rotate or swivel freely about its longitudinal axis to allow free rotation of the vane when wind is applied. The other end 76 of the toggle 72 may allow for the attachment to the warning marker vane. The attachment may also be a similar strap. Preferably, when the warning marker is in use, the warning marker vane is positioned below the jaws. The distance between the warning marker vane and the jaws may be of a safe predetermined distance away such that in windy conditions, the rotating vane may not impede the use of the warning marker as well as being away from contacting the live transmission line. The advantage of having a warning marker vane is to allow the user to make an informed safety decision whether the weather condition, such as wind condition, is suitable to conduct the activity.

It may be appreciated that the warning marker and/or the application tool may be constructed of any non-conducting material in which the material may be resilient and with a high tensile strength to withstand the force against the spring tension of the spring biasing means, when in use. Preferably, the material may be Nylon-6, high density polyethylene, polypropylene, or acrylonitrile butadiene styrene. It may be appreciated that any type of high tensile strength polymer may be used. Nonconducting materials may allow a user to safely use the warning marker and the application tool in high voltage live transmission lines. It would be appreciated that the base means may be constructed from metal for increasing structural strength and structural integrity.

The application tool 80 of the apparatus of the present invention comprises a base means 90 and a top protrusion 82 and a bottom protrusion 86 protruding from a front surface 92 of the base means 90. The top protrusion 82 and the bottom protrusion 86 are adapted to engage with the first handle means 24 and the second handle means 30. The top protrusion is moveable relative to the bottom protrusion via the longitudinal axis of the screw. When the protrusions are engaged with the respective handles, the movement of the top protrusion towards the bottom protrusion moves the handles towards each other and opens or urges the at least one securing means apart to allow the transmission line to be received in the at least one securing means. When the transmission line has been received in the at least one securing means, the movement of the top protrusion away from the bottom protrusion moves the handles away from each other to return the at least one securing means to the original spring-biased configuration, allowing for the diameter of the transmission line once the warning marker is installed. Existing methods for applying warning marker devices to transmission lines can use a screw-based means. However, existing tools use integrated screw mechanisms that typically use a large number of turns to fully engage and therefore can take a significant amount of time to engage and disengage with the marker device during the application process. Surprisingly, the relatively large screw mechanism 94 of the present invention (preferably the diameter of the screw is between 30 to 50 mm with a thread extending from the screw surface up to 10 mm) can travel between around 70 mm to 90 mm per rotation of the application tool. Thus, the application tool of the present invention can effectively open or urge the at least one securing means of the marker device apart within a maximum of around three full rotations of the tool. This makes the combined warning marker/application tool apparatus of the present invention relatively easy to use in comparison with existing application tools having screw threads closer relative to each other, which may require as many as twenty to thirty full rotations of the tool before the securing means are opened or urged apart.

An opening means 96 is attached to a bottom surface 98 of the base means 90, the opening means 96 being adapted to receive a support means 100 adapted to position the warning marker 10. The top protrusion 82 and the bottom protrusion 86 of the application tool 80 are adapted to releasably engage with the first jaw 20 and the second jaw 28 of the warning marker device 10 to position and attach the warning marker 10 to the transmission lines.

The bottom protrusion 86 is moveable relative to the top protrusion 82 via the longitudinal axis of the screw. The protrusions 82, 86 engage with the respective handles, and the movement of the bottom protrusion 86 towards the top protrusion 82 moves the handles towards each other and opens or urges the at least one securing means to allow the transmission line to be received in the at least one securing means. When the transmission line has been received in the at least one securing means, the movement of the bottom protrusion away from the top protrusion moves the handles away from each other to return the at least one securing means to the original spring-biased configuration. During engagement and disengagement of the warning marker device 10 with the transmission lines, the spring-biased clamp means 46 has a 90° abutting relationship to the transmission lines. The application tool 80 of the apparatus can be rested against the transmission lines during the engagement and disengagement process of the warning marker device 10 with the transmission lines.

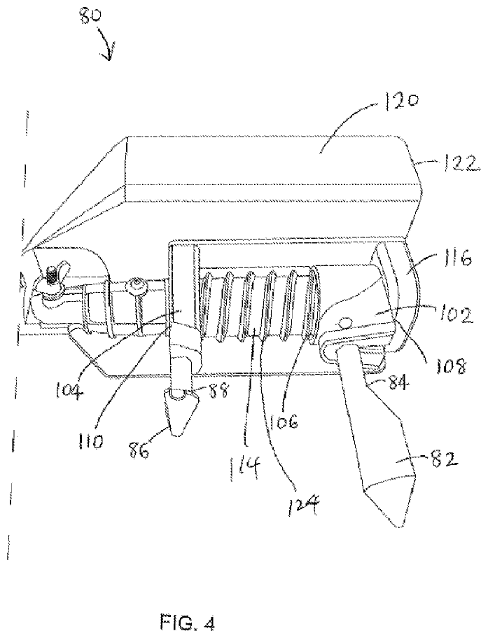

The bespoke application tool 80 may have a top protrusion 82 or a first protrusion and a bottom protrusion 86 or a second protrusion. As illustrated in FIG. 4, the top protrusion 82 may be larger and longer than the bottom protrusion 86. The top protrusion 82 may have a bevelled edge 84 for engaging with the first loop handle 34. The bottom protrusion 86 may have an umbrella shape 88 for engaging with the second loop handle 36. The top protrusion 82 may be larger so that when trying to hook onto the first loop handle 34, this top protrusion 82 may be able to find and pass through the first hole 38 efficiently. As the distance between the top protrusion 82 and the bottom protrusion 86 is of a set predetermined distance, the bottom protrusion 86 will be able to engage with the second loop handle 36 once the top protrusion 82 has engaged with the first loop handle 34.

The top protrusion 82 may be mounted to a first nut 102 and the bottom protrusion 86 may be mounted to a second nut 104. The first nut 102 may have a first bore 106 with a thread pitch 108 that may be engageable with a screw 114. Similarly, the second nut 104 may have a second bore 110 with also with a thread pitch 112 that may be engageable with the screw 114. For additional support, there may be provided a protrusion support bracket 116, in which the first nut 102 and the second nut 104 are mounted.

An elongated application tool handle may be mounted at an end 118 of the application tool 80 parallel to the longitudinal axis of the screw 114. It may be appreciated that the tool handle may be of a sufficient length so that a user on the ground can reach the transmission line of a predetermined height above the ground. It may be appreciated that there may be multiple live transmission lines running in parallel or adjacent with respect to each other. As such, there application tool 80 also comprise a mounting bracket 120, in which a predetermined width 122 of the bracket is adapted to rest against an adjacent transmission line, if the adjacent transmission line is in the way from the installation of the warning marker to allow sufficient space for the user to clamp the warning marker to the desired transmission line. The mounting brackets also serve to block or impeded the rotation of the entire body of the warning marker when the screw 114 is rotated whereby allowing the mechanical advantage of the rotation of the screw 114 to be directed, as much as possible, in the motion of the moving the loop handles of the warning marker rather than twisting the entire body of the warning marker.

The mounting bracket may have a proximal end and a distal end, in which the proximal end may be closest to the handle and the distal end may be furthest to the handle. The proximal end of the mounting bracket may have a bevelled edge or a ramp. The bevelled edge may be shaped for the purposes that the transmission line or cable, when contacting the bevelled edge, the transmission line can slide towards the protrusions. This bevelled edge feature of the tool minimises the risk of the transmission line being caught between the tool parts as the user is pulling the tool down, if the user has accidentally raised the tool higher than the transmission line to install or uninstall the warning marker.

The screw 114 may have thread pitch 124 that allows for a user to turn less when attempting to install or uninstall the warning marker device from the transmission line. When installing or uninstalling the marker device, to apply the squeezing force to the scissor mechanism, the bottom protrusion 86 may move relatively towards the top protrusion 82 along the thread of the screw 124 when a user is applying a torque force in a direction to the elongated handle. The decreased distance between the top protrusion 82 and the bottom protrusion 86 moves the first loop handle 34 and the second loop handle 36 relatively toward each other. Conversely to decrease the squeezing force to the loop handles 34, 36, the user can apply a torque force in the other direction to the elongated handle. The increased distance between the top protrusion 82 and the bottom protrusion 86 moves the first loop handle 34 and the second loop handle 36 relatively away from each other.

Preferably, the screw 114 may also be described as an elongated threaded rod. At the lower or bottom end of the screw 114 is integrally moulded a lockable toothed joint. The lockable toothed joint allows for the reception and joining of an electrician's hot stick. The teeth of the distal end hot stick are adapted to engage the corresponding teeth of the lockable teethed joint. The joint and hot stick are bolted together using a nut and bolt passing through the centre of the joint. The nut is adapted to be tightened by the hand of a user using a wing nut.

In the electric power distribution industry, a hot stick is an insulated pole, usually made of fiberglass, used by electric utility workers when engaged on live-line working on energized high-voltage electric power lines, to protect them from electric shock. Depending on the tool attached to the end of the hot stick, it is possible to test for voltage, tighten nuts and bolts, apply tie wires (twisted lengths of ductile wire which fasten the running cable to its supporting insulators), open and close switches, replace fuses, lay insulating sleeves on wires, and perform various other tasks while not exposing the crew to a large risk of electric shock.

Hot sticks are made in different lengths, from simple 3-foot (1 m) sticks to 30-foot (9 m) telescoping models. Because the fiberglass provides electrical insulation, the hot stick allows utility workers to perform operations on power lines safely without de-energizing them or while the state of the power line is not yet known. This is essential because certain operations (such as opening or closing combination fuse/switches) must occasionally be performed on an energized line. Additionally, after a fault occurs, the exact state of a line may not be certain; in this case, for reasons of crew safety, the utility workers must treat the line as though it were energized until it can be proven that it is not and safety ground cables can be applied to the line (so that the line is guaranteed to remain grounded/earthed while maintenance is performed upon it). If power tools are fitted to the end of the hot stick, they are usually powered hydraulically rather than electrically because, like the fiberglass of the hot stick, the hydraulic fluid is also a good insulator. The hydraulic power is commonly supplied from the bucket truck (cherry picker or aerial work platform) supporting the workers.

The hot stick not only electrically insulates the worker from the energized conductor, it provides physical separation from the device being operated, to reduce the chances of burns which might result from electrical arcing if there is a malfunction of the device being operated.

In the United States, ASTM Standard F 711 specifies the stringent requirements for hot sticks, and U.S. OSHA standards require that they be inspected and electrically tested every two years. Preferably, the warning marker and application tool are both also adapted to comply with regulatory standards relating to electrical components of this type. A failure of many previously known systems is that the systems are difficult to remove and may damage the power/transmission lines to which they are attached.

In this embodiment, the warning marker and application tool are adapted to allow to the easy installation and uninstallation. The warning marker and application tool adapted to work together in a system. Preferably the warning marker may be adapted include security key locking mechanisms to only allow for a particular unique keyed application tool to remove the marker (not shown).

It may be appreciated that every part of the warning marker and the application tool is constructed of a nonconductive material for the user's safety.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. An apparatus adapted for attachment to transmission lines, the apparatus comprising:
a warning marker; and
a warning marker application tool for applying the warning marker to transmission lines;
wherein the warning marker comprises:
at least one securing means adapted to engage the transmission lines;
a first handle and a second handle each connected to the at least one securing means;
a spring-biased clamp means adjacent the proximal end at the least one securing means; and
an attachment means adjacent the at least one securing means; and
wherein the application tool comprises:
a base means;
a first protrusion and a second protrusion each protruding from a surface of the base means; and
a screw mechanism attached to the base means;
wherein the first protrusion and the second protrusion are each adapted to releasably engage with the first handle and the second handle respectively, to position and clamp the warning marker to the transmission lines.

2. The apparatus of claim 1 wherein the second protrusion is moveable relative to the first protrusion via the longitudinal axis of the screw mechanism.

3. The apparatus of claim 2 wherein when the protrusions are engaged with the respective handles, the movement of the second protrusion towards the first protrusion moves the handles towards each other to open the at least one securing means.

4. The apparatus of claim 3 wherein the transmission line can be received in the at least one securing means.

5. The apparatus of claim 2, wherein the movement of the second protrusion away from the first protrusion moves the handles away from each other which returns the at least one securing means to the spring-based configuration.

6. The apparatus of claim 1 wherein the spring-biased clamp means has a 90° abutting relationship to the transmission lines.

7. The apparatus of claim 1 comprising a first securing means and a second securing means.

8. The apparatus of claim 1 wherein the movement of the second protrusion relative to the first protrusion along the longitudinal axis of the screw mechanism is a torsional movement

9. The apparatus of claim 8 wherein rotational force applied to the application tool is used to instigate the torsional movement

10. The apparatus of claim 8 wherein torsional force is applied to the application tool to enable clamping movement of the first securing means relative to the second securing means to position and clamp the warning marker to the transmission lines.

11. The apparatus according to claim 7 wherein the first securing means is a first jaw and the second securing means is a second jaw, wherein the first jaw is movably attached to the second jaw.

12. The apparatus of claim 1 wherein the application tool comprises a top protrusion and a bottom protrusion.

13. The apparatus of claim 12 wherein the top protrusion and the bottom protrusion are adapted to engage with the first handle means and the second handle means of the warning marker.

14. The apparatus of claim 12 wherein, in use, the top protrusion engages the first handle enabling the first jaw to connect the transmission line and the bottom protrusion engages the second handle.

15. The apparatus of claim 1 wherein the attachment means is adapted at attach to a warning marker vane.

16. The apparatus of claim 15 wherein the top protrusion is shaped to recover the warning marker device during application of the device on the transmission line.

17. An apparatus adapted for attachment to transmission lines, the apparatus comprising: a warning marker; and a warning marker application tool for applying the warning marker to transmission lines;
wherein the warning marker comprises:
a first jaw and a second jaw, the first jaw movably attached to the second jaw at their respective proximal ends, a first handle means attached to proximal end of first jaw and a second handle means attached to proximal end of second jaw;
a spring-biased clamp means adjacent a top surface of the first jaw;
an attachment means adapted to attach to a warning marker vane; and
wherein the application tool comprises:
a base means;
a top protrusion and a bottom protrusion protruding from a front surface of the base means, the top protrusion and the bottom protrusion adapted to engage with the first handle means and the second handle means respectively;
a screw mechanism adjacent the top protrusion and the bottom protrusion;
wherein the screw mechanism is used to move the top protrusion and the bottom protrusion towards each other to open or urge the first jaw and the second jaw apart to receive the transmission lines.

18. The apparatus of claim 17 wherein the top protrusion is moveable relative to the bottom protrusion via the longitudinal axis of the screw mechanism.

19. The apparatus of claim 17 wherein the top protrusion is parallel to the bottom protrusion, and wherein the top protrusion is relatively offset to the bottom protrusion.

20. The apparatus of claim 19 wherein the offset is of a distance in the range of 0 mm to 30 mm.
